(19) United States
(12) Patent Application Publication
(10) Pub. No.: US 2013/0076035 A1
(43) Pub. Date: Mar. 28, 2013

(54) MOTOR-GENERATOR TURBOMACHINE STARTER

(71) Applicants: Andreas C. Koenig, Machesney Park, IL (US); Adam M. Finney, Rockford, IL (US)

(72) Inventors: Andreas C. Koenig, Machesney Park, IL (US); Adam M. Finney, Rockford, IL (US)

(21) Appl. No.: 13/246,827

(22) Filed: Sep. 27, 2011

(51) Int. Cl. F02N 11/08

(52) U.S. Cl. 290/34; 290/46

(57) ABSTRACT

An exemplary turbomachine starter assembly includes a motor-generator that selectively operates in a motor mode or a generator mode. The motor-generator provides a rotational input to a turbomachine when operating in the motor mode. The motor-generator generates a supply of electrical power when operating in the generator mode. The supply of electrical power is used to power accessories of the turbomachine.

### BACKGROUND

This disclosure relates generally to starting—and providing power to the accessories of—a turbomachine.

Turbomachines are used to propel aircraft, for example. A typical turbomachine includes a fan section, a compression section, a combustor section, and a turbine section. Turbomachines have at least one rotor in the compression section. The rotor must be accelerated to a relatively high rotational speed until the rotor is rotating fast enough to sustain operation of the turbomachine. Starters are used to accelerate the rotor. Example starters include air turbine starters, jet fuel starters, and electric motor starters.

In some current designs, a first electric motor rotates the rotor during start-up of the turbomachine. A second electric motor powers the accessories of the turbomachine, such as a full-authority digital electronic control (FADEC). The first motor is much larger than the second motor. The second motor is typically a low-voltage, low-power, permanent magnet generator.

### SUMMARY

An exemplary turbomachine starter assembly includes a motor-generator that selectively operates in a motor mode or a generator mode. The motor-generator provides a rotational input to a turbomachine when operating in the motor mode. The motor-generator generates a supply of electrical power when operating in the generator mode. The supply of electrical power is used to power accessories of the turbomachine.

An exemplary turbomachine and starter assembly includes a turbomachine and a motor-generator that is selectively operated in a motor mode or a generator mode. The assembly includes a gearing arrangement rotatably coupling the motor-generator with the turbomachine. The motor-generator in the motor mode rotates the turbomachine to start the turbomachine. The motor-generator in the generator mode is rotated by the turbomachine. The motor-generator in the generator mode generates a supply of electrical power that is used to power accessories of the turbomachine.

An exemplary method of powering turbomachine accessories includes rotating a turbomachine during a start-up of the turbomachine using a motor-generator and generating a supply of power with the motor-generator after the start-up. The method uses the supply of power to power an accessory of the turbomachine.

### DESCRIPTION OF THE FIGURES

The various features and advantages of the disclosed examples will become apparent to those skilled in the art from the detailed description. The figures that accompany the detailed description can be briefly described as follows:

FIG. 1 shows a schematic view of an example turbomachine and starter assembly.

FIG. 2 shows a schematic view of the FIG. 1 assembly in a motor mode.

FIG. 3 shows a schematic view of the FIG. 1 assembly in a generator mode.

### DETAILED DESCRIPTION

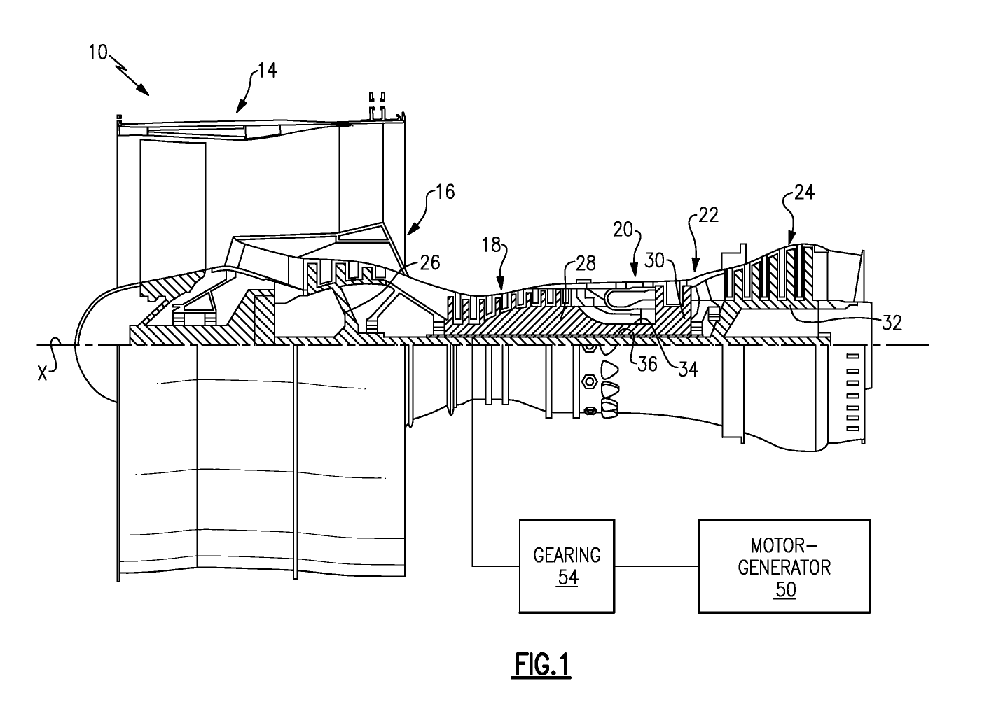

Referring to FIG. 1, an example gas turbine engine 10 is used to propel an aircraft. The gas turbine engine 10 is an example type of turbomachine.

The gas turbine engine 10 is circumferentially disposed about an axis X. The gas turbine engine 10 includes a fan section 14, a low-pressure compressor section 16, a high-pressure compressor section 18, a combustion section 20, a high-pressure turbine section 22, and a low-pressure turbine section 24. Other example gas turbine engines may include more or fewer sections.

During operation, the low-pressure compressor section 16 and the high-pressure compressor section 18 compress air. The compressed air is then mixed with fuel and burned in the combustion section 20. The products of combustion are expanded across the high-pressure turbine section 22 and the low-pressure turbine section 24.

The low-pressure compressor section 16 includes a rotor 26. The high-pressure compressor section 18 includes a rotor 28. The example rotors 26 and 28 include alternating rows of rotating airfoils or rotating blades and static airfoils or static blades.

The high-pressure turbine section 22 includes a rotor 30. The low-pressure turbine section 24 includes a rotor 32. The rotors 30 and 32 rotate about the axis X in response to expansion across the high-pressure turbine section 22 and the low-pressure turbine section 24. The example rotors 30 and 32 include alternating rows of rotatable airfoils or rotatable blades and static airfoils or static blades.

The rotor 30 is coupled to the rotor 28 through a high-pressure spool 34. The rotor 32 is coupled to the rotor 26 through a low-pressure spool 36. Rotation of the rotors 30 and 32 rotates the rotors 28 and 26, which drives compression in the high-pressure compressor section 18 and the low-pressure compressor section 16, respectively. During operation of the gas turbine engine 10, the low-pressure spool 36 rotates across a greater range of rotational speeds than the high-pressure spool 34.

Although a turbomachine in this disclosure is described with reference to the gas turbine engine 10 having a two-spool architecture, the examples are not limited to such architectures. Other types of turbomachines may be used. Also, gas turbine engines having other architectures, such as a single-spool axial design, a three-spool axial design, may be used. That is, there are various turbomachines that could benefit from the examples disclosed herein.

In this example, a turbomachine starter assembly, such as a motor-generator 50, is rotatably coupled to the gas turbine engine 10 with a gearing arrangement 54. The motor-generator 50 is selectively operable in a motor mode or a generator mode (also referred to as generate mode). In the motor mode, the motor-generator 50 rotates the high-pressure spool 34 of the gas turbine engine 10. In the generator mode, the high-pressure spool 34 rotates the motor-generator 50. When rotated in the generator mode, the motor-generator 50 provides electrical power to various loads associated with accessories of the gas turbine engine 10.

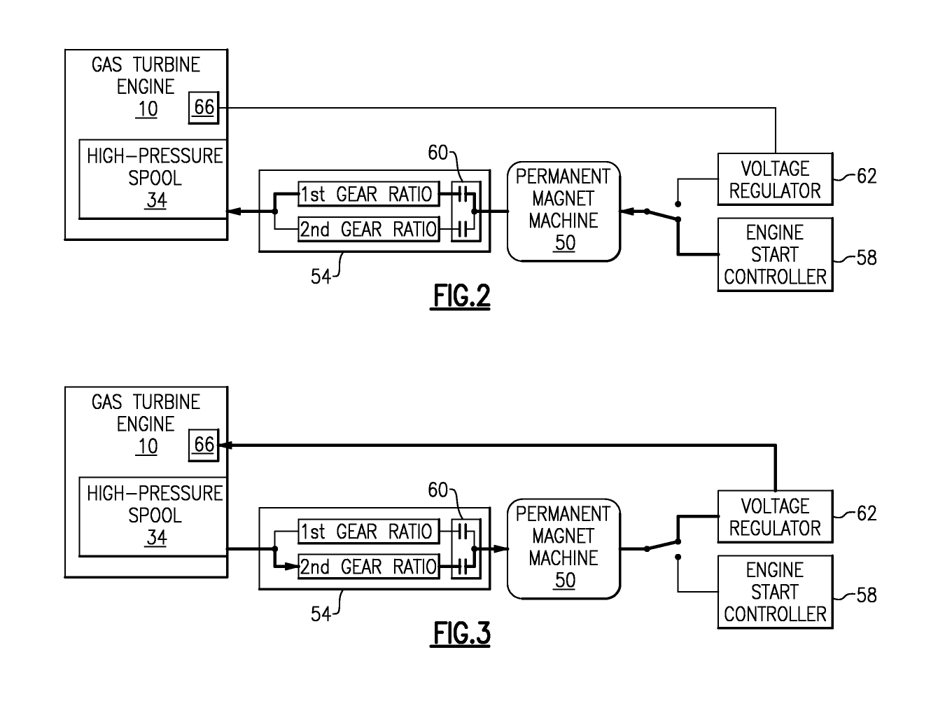

Referring to FIGS. 2 and 3 with continuing reference to FIG. 1, the example gearing arrangement 54 operates with either a first gear ratio or a second gear ratio. The gearing arrangement 54 is alternated between the first gear ratio and the second gear ratio depending on whether the motor-generator 50 is operating in the motor mode or the generator mode. The gearing arrangement 54 thus acts as a two-speed transmission.

The example motor-generator 50 is a permanent magnet machine that has a relatively wide speed range. A power rating of the example motor-generator 50 is appropriate for starting the gas turbine engine 10. Notably, the motor-generator 50 is much smaller than motor-generators used elsewhere on the aircraft.

When the motor-generator 50 operates in the motor mode, the gearing arrangement 54 operates with the first gear ratio, which steps down rotation of the motor-generator 50 relative to rotation of the high-pressure spool 34. The motor-generator 50 thus spins faster than the high-pressure spool 34 when the motor-generator 50 operates in the motor mode. In one example, the motor-generator 50 spins 11 times faster than the high-pressure spool 34 when the motor-generator 50 operates in the motor mode. The relatively high rotational speed allows for a compact motor-generator.

When the motor-generator 50 operates in the generator mode, the gearing arrangement 54 operates with the second gear ratio, which is lower than the first gear ratio. Using the second gear ratio rather than the first gear ratio allows the motor-generator 50 to spin slower relative to the rotational speed of the high-pressure spool 34. The high-pressure spool 34 drives rotation of the motor-generator 50 using the second gear ratio.

In this example, during an operating procedure, an engine start controller 58 initiates movement of the motor-generator 50 to start rotation of the gas turbine engine 10. The engine start controller 58 also ensures that the gearing arrangement 54 is operating using the first gear ratio. The engine start controller 58 may initiate movement if a mechanical coupling 60 of the gearing arrangement 54, such as a clutch, to operate the gearing arrangement 54 with the first gear ratio or the second gear ratio.

The example motor-generator 50 rotates gearing arrangement 54 to directly rotate the high-pressure spool 34 during start-up. The motor-generator 50 thus provides a rotational input to the gas turbine engine 10 during start-up. In another example, the motor-generator 50 rotates gearing arrangement 54 to directly rotate the low-pressure spool 36 during start-up of the gas turbine engine 10.

After the high-pressure spool 34 of the gas turbine engine 10 reaches a self-sustaining rotational speed, the motor-generator 50 switches from the motor mode to the generator mode. The engine start controller 58 is also decoupled from the motor-generator 50. In the generator mode, the gearing arrangement 54 adjusts to operate with second gear ratio instead of the first gear ratio. The high-pressure spool 34 then drives the motor-generator 50 to generate a supply of electrical power.

In the generator mode, a voltage regulator 62 may be used to regulate power from the motor-generator 50 and to ensure the power is at an appropriate level.

Notably, power from the motor-generator 50 is used to primarily power accessories 66 of the gas turbine engine 10, such as a full-authority digital electronic control (FADEC) or valves of the gas turbine engine 10. Accessories of the gas turbine engine 10 are accessories that are associated with, or mounted to, the gas turbine engine 10. The example accessories are electrically driven engine loads, which are required for operation of the gas turbine engine 10. A person having skill in this art and the benefit of this disclosure would understand suitable accessories of the gas turbine engine 10.

In some examples, power from the motor-generator 50 is used exclusively to power accessories of the gas turbine engine 10. In such examples, no other areas of the aircraft are provided with power from the motor-generator 50. Power from the motor-generator 50 is converted to direct current before powering the accessories 66.

In one example, the motor-generator 50 operates through its entire speed range when in the motor (or start) mode with the first gear ratio. The motor-generator 50 then changes to the generator mode with the second gear ratio. Changing to the second gear ratio prevents the high-pressure spool 34 from overspeeding the motor-generator 50 and damaging the motor-generator.

Operating the motor-generator 50 at the lower speeds with the second gear ratio also reduces mechanical and electromagnetic losses. Operating at the lower speed with the second gear ratio is possible because the power required to power accessories 66 of the gas turbine engine 10 is less than the power required to start the gas turbine engine 10. If the gear ratio between the motor-generator 50 and the gas turbine engine 10 were fixed, the motor-generator 50 would need to be much larger.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A turbomachine starter assembly, comprising:
a motor-generator that selectively operates in a motor mode or a generator mode, the motor-generator providing a rotational input to a turbomachine when operating in the motor mode, the motor-generator generating a supply of electrical power when operating in the generator mode, wherein the supply of electrical power is used to power accessories of the turbomachine.

2. The turbomachine starter assembly of claim 1, wherein the turbomachine rotatably drives the motor-generator when the motor-generator operates in the generator mode.

3. The turbomachine starter assembly of claim 1, wherein a high-speed spool of the turbomachine rotatably drives the motor-generator when operating in the generator mode.

4. The turbomachine starter assembly of claim 1, wherein the rotational input is provided to the turbomachine to start the turbomachine.

5. The turbomachine starter assembly of claim 1, wherein the motor-generator rotates at a first speed and the turbomachine rotates at a second speed, and a difference between the first speed and the second speed is greater when the motor-generator operates in the motor mode than when motor-generator operates in the generator mode.

6. The turbomachine starter assembly of claim 1, wherein the motor-generator is a permanent magnet machine.

7. The turbomachine starter assembly of claim 1, wherein the supply of electrical power is used to power a full authority digital electronic control.

8. A turbomachine and starter assembly, comprising:
a turbomachine;
a motor-generator that is selectively operated in a motor mode or a generator mode; and
a gearing arrangement rotatably coupling the motor-generator with the turbomachine, the motor-generator in the motor mode rotating the turbomachine to start the turbomachine, the motor-generator in the generator mode rotated by the turbomachine, wherein the motor-generator in the generator mode generates a supply of electrical power that is used to power accessories of the turbomachine.

9. The turbomachine and starter assembly of claim 8, wherein the gearing arrangement has a gearing ratio, and the gearing ratio when the motor-generator is in the motor mode is higher than the gearing ratio when the motor-generator is in the generator mode.

10. The turbomachine and starter assembly of claim 8, wherein the supply of electrical power is used exclusively to power accessories of the turbomachine.

11. The turbomachine and starter assembly of claim 8, including a voltage regulator electrically coupled to the motor-generator in the generator mode and electrically decoupled from the motor-generator in the motor mode, the voltage regulator regulating the supply of electrical power when electrically coupled to the motor-generator.

12. The turbomachine and starter assembly of claim 8, including an engine start controller operatively coupled to the motor-generator in the motor mode and operatively decoupled from the motor-generator in the generator mode, the engine start controller controlling a rotational speed of the motor-generator when rotatably coupled to the motor-generator.

13. The turbomachine and starter assembly of claim 8, wherein the motor-generator is a permanent magnet machine.

14. The turbomachine and starter assembly of claim 8, wherein the supply of electrical power is used to power a full-authority digital electronic control.

15. The turbomachine and starter assembly of claim 8, wherein the gearing arrangement is a two-speed transmission.

16. A method of powering turbomachine accessories, comprising:
rotating a turbomachine during a start-up of the turbomachine using a motor-generator;
generating a supply of power with the motor-generator after the start-up; and
using the supply of power to power an accessory of the turbomachine.

17. The method of claim 16, wherein the accessory is a full-authority digital electronic control.

18. The method of claim 16, wherein the motor-generator is a permanent magnet machine.

19. The method of claim 16, wherein the motor-generator rotates the turbomachine using a first gear ratio during start-up, and the turbomachine rotates the motor-generator using a second, different gear ratio after the start-up.

20. The method of claim 19, wherein the first gear ratio is higher than the second gear ratio.
